(19) United States
(12) Patent Application Publication
(10) Pub. No.: US 2005/0275879 A1
(43) Pub. Date: Dec. 15, 2005

(54) Display device, display system, and display method

(75) Inventor: Kenji Ogasawara, Toda-Shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 10/938,562

(22) Filed: Sep. 13, 2004

(30) Foreign Application Priority Data
May 27, 2004 (JP) 2004-157811

(51) Int. Cl. G06K 15/02; G06F 17/24; G06F 15/163

(52) U.S. Cl. 358/1.15; 715/527; 358/1.18

(57) ABSTRACT

The server device of the display system prepares preview image data for showing a completed state of a book being produced containing an image showing how paper being turned bends depending on the selected type of paper.

This application is based on Japanese Patent Application No. 2004-157811 filed on May 27, 2004, the contents of which are hereby incorporated by reference.

### BACKGROUND OF THE INVENTION

1. Field of the Invention

The invention relates to a display device, a display system, and a display method. The invention relates more specifically to a display device, a display system, and a display method for displaying preview image data indicating the state of completion of a book being produced.

2. Description of the Related Art

On-demand printing is a commonly practiced print method today. According to the on-demand printing technology, a client device of a user, who desires printing, is connected to a server device of a printing company at a remote location via a network such as the Internet. The user transmits its image data via the network to the printing company's server device requesting it to be printed. The requested printing company performs the printing based on the image data it receives.

In such an on-demand printing, it is a common practice for the printing company to transmit preview image data showing the state of the completed print prior to the actual printing from the printing company's server device to the client device in order to receive the user's confirmation.

As a part of such preview technology, a technology that allows the qualities of the paper to be used in print such as, smoothness, glossiness, transparency and tone, to be reflected on the preview image data is known (refer to: Unexamined Publication No. JP-A-2002-103726).

In the meanwhile, the parameters of the recent on-demanding printing orders have become quite diverse such as selection of the type of paper finishing process on the printed paper, book binding, etc.

Unfortunately, the technology disclosed by the above citation has been incapable of meeting all the varieties on these order parameters. In other words, there have been cases where the finished states of the books produced according to the orders are not exactly how the users imagined. This not only left the users unsatisfied but also caused them to reorder in some cases.

### SUMMARY OF THE INVENTION

It is an object of the present invention to provide a display device, a display system and a display method, which are improved for solving the abovementioned problems.

The invention's more specific object is to provide a display device, a display system, and a display method that are capable of showing a preview of the state of completion of the book being produced to a user.

According to an aspect of the invention, there is provided a display device, comprising: a storage unit for storing a plurality of types of paper; a paper selection unit for selecting a type of paper to be used; a preview image preparation unit for preparing preview image data for showing a completed state of a book being produced containing an image showing how paper being turned bends depending on the type of paper selected; and a display unit for displaying the prepared preview image data.

According to this invention, the user can check a preview image data including an image showing how the paper bends as it is turned over on a display before book binding actually. This is how it is made possible for the user to accurately grasp beforehand the state of completion of a book being produced, so that it is possible to avoid a book from being produced differently from what the user intended. This assures the user a more satisfactory result from the book making and prevents the user from having to be in a position to reorder.

According to another aspect of the invention, there is provided a display system, comprising: a client device; and a server device communicable with said client device, wherein said client device including: a paper selection unit for selecting a type of paper to be used; a transmission unit for transmitting information regarding the selected paper type to said server device; a reception unit for receiving from said server device preview image data showing the completed state of the book being produced indicating how paper being turned bends; a display unit for displaying the received preview image data; said server device including: a reception unit for receiving from said client device information regarding the selected type of paper; a preview image preparation unit for preparing the preview image data in accordance with the received information regarding the type of paper; and a transmission unit for transmitting the prepared preview image data to said client device.

According to still another aspect of the invention, there is provided a display method comprising the steps of: 1) receiving the selection of the type of paper intended to be used among a plurality of types of paper stored in the storage unit; 2) preparing preview image data for showing a completed state of a book being produced containing an image showing how paper being turned bends depending on the type of paper selected; and 3) displaying the prepared preview image data.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall constitution of a display system according to an embodiment of the present invention.

FIG. 2 is a block diagram showing the constitution of the client device shown in FIG. 1.

FIG. 3 is a block diagram showing the constitution of the server device shown in FIG. 1.

FIG. 4 is a diagram for describing paper information database and a print data storage unit.

FIG. 5 is a diagram showing an example of the paper information list.

FIG. 6 is a diagram for describing a printing service processing unit and a preview image preparation unit.

FIG. 7 is a flow chart showing the process procedure on the client device.

FIG. 8 is a diagram showing an example of a preview request job.

FIG. 9 is a display example of the preview image data when heavy paper is selected for a cover.

FIG. 10 is a display example of the preview image data when normal paper is selected for a cover.

FIG. 11 is a display example of the preview image data when fine quality writing paper is selected for a cover.

FIG. 12 is a diagram showing an example of a print request job.

FIG. 13 is a flowchart showing the process procedure on the server device.

FIG. 14 is a flowchart showing the process procedure on the server device continued from FIG. 13.

FIG. 15 is a flowchart showing the process of the preview image data preparation.

FIG. 16 is a plan view showing an example of the left side binding.

FIG. 17 is a plan view showing an example of the top left corner binding.

FIG. 18 is a diagram for describing the trace of the pickup point when the binding is on the left side and the pickup point is at the point C.

FIG. 19 is a diagram for describing the trace of the pickup point when the binding is on the top left corner and the pickup point is at the point G.

FIG. 20 is a diagram showing an example of the preview image data including an image showing how a cover is bent when the cover is turned if the cover uses paper with a bending easiness of α=0.

FIG. 21 is a diagram showing an example of the preview image data including an image showing how a cover is bent when the cover is turned if the cover uses paper with a bending easiness of α=0.5.

FIG. 22 is a diagram showing an example of the preview image data including an image showing how a cover is bent when the cover is turned if the cover uses paper with a bending easiness of α=1.

FIG. 23 is a diagram showing an example of the preview image data including an image showing how a cover is bent when the cover is turned if the cover uses paper with a bending easiness of α=2.

FIG. 24 is a diagram for describing the shape of side IJ when a bending easiness α=1.

FIG. 25 is a diagram for describing the shape of side IJ when a bending easiness α is larger than 1 and smaller than 2.

FIG. 26 is a diagram for describing the shape of side IJ when a bending easiness α=2.

FIG. 27 is a diagram showing an example of preview image data showing a binding margin.

FIG. 28 is a diagram showing an example of preview image data when the first ⅓ pages are turned over.

FIG. 29 is a diagram showing an example of preview image data when the first ⅔ pages are turned over.

FIG. 30 is a diagram for describing how the already turned paper bends when the bending easiness α is larger than 0 and smaller than 1.

FIG. 31 is a diagram for describing how the already turned paper bends when the bending easiness α=1.

FIG. 32 is a diagram for describing how the already turned paper bends when the bending easiness α is larger than 1 and smaller than 2.

FIG. 33 is a diagram for describing how the already turned paper bends when the bending easiness α=2.

FIG. 34 is a diagram for describing how the paper bends when the paper used for the cover and the back cover is different from the paper used for pages other than the cover and the back cover.

FIG. 35 is a plan view showing an example of paper where the specified image corresponding to the print data is printed.

FIG. 36 is a diagram showing an example image of how the paper on which the image shown in FIG. 35 is printed bends.

FIG. 37 is a diagram for describing how an image is projected on a curved surface.

FIG. 38 is a diagram for describing how an image is projected on a curved surface.

### DETAILED DESCRIPTION OF THE PREFERRED EMBODIMENTS

The embodiments of this invention will be described below with reference to the accompanying drawings.

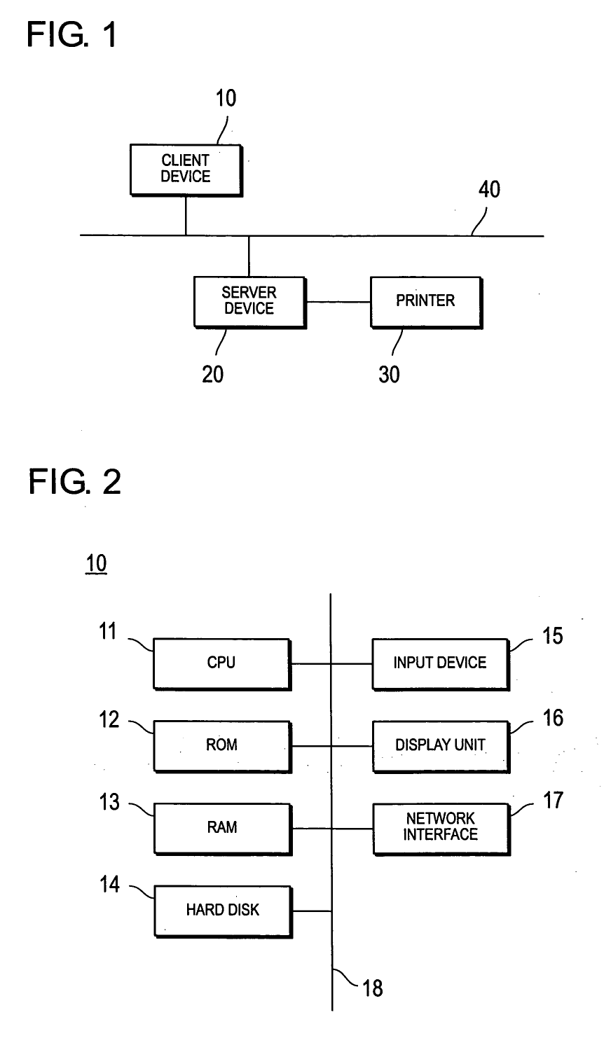

FIG. 1 is a block diagram showing the overall constitution of a print system according to an embodiment of the present invention. The display system shown in FIG. 1 has a client device 10, a server device 20, and a printer 30. The client device 10 and the server device 20 are communicably connected with each other via a network 40. The server device 20 and the printer 30 are connected directly between the equipment (“local connection”). The types and the number of equipment to be connected to the network 40 are not limited to those shown in FIG. 1.

The server device 20 is capable of receiving from the client device 10 preview request jobs for requesting preview image data that indicate the state of completion of books being produced, or print request jobs for requesting print processes including book binding.

FIG. 2 is a block diagram showing the constitution of the client device shown in FIG. 1.

The client device 10 is, for example, a common personal computer (PC). As shown in FIG. 2, the client device 10 contains a CPU 11, a ROM 12, a RAM 13, a hard disk 14, an input device 15, a display unit 16, and a network interface 17, all of which are interconnected by a bus 18 for exchanging signals.

The CPU 11 controls various parts indicated above and executes various arithmetic processes according to a program. The ROM 12 stores various programs and data. The RAM 13 stores programs and data temporarily as a working area. The hard disk 14 stores various programs including an operating system and various data.

The input device 15 consists of a pointing device such as a mouse, a keyboard, and others, and is used for making various kinds of inputs. The display unit 16 is, for example, a liquid crystal display and is used for displaying various kinds of information.

The network interface 17 is an interface to connect with the network 40 for communicating with other devices on the network using standards such as Ethernet®, Token Ring, FDDI, etc.

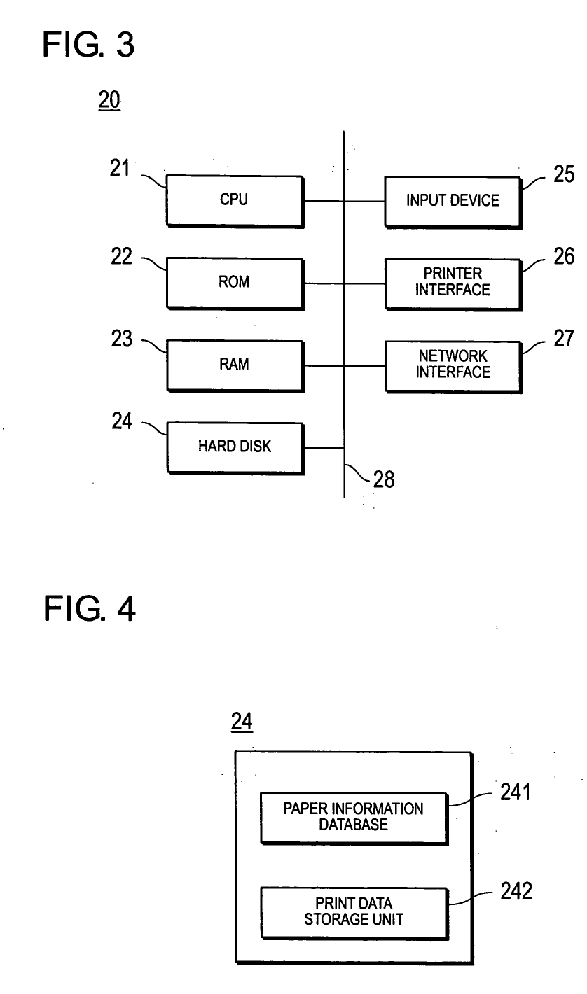

FIG. 3 is a block diagram showing the constitution of the server device shown in FIG. 1.

This server device 20 is a server computer. As shown in FIG. 3, the server device 20 contains a CPU 21, a ROM 22, a RAM 23, a hard disk 24, an input device 25, a printer interface 26, and a network interface 27, all of which are interconnected by a bus 28 for exchanging signals.

The descriptions of those parts of the server device 20 that have the same functions as those of the corresponding parts of the client device 10 will be omitted here to avoid being duplicative.

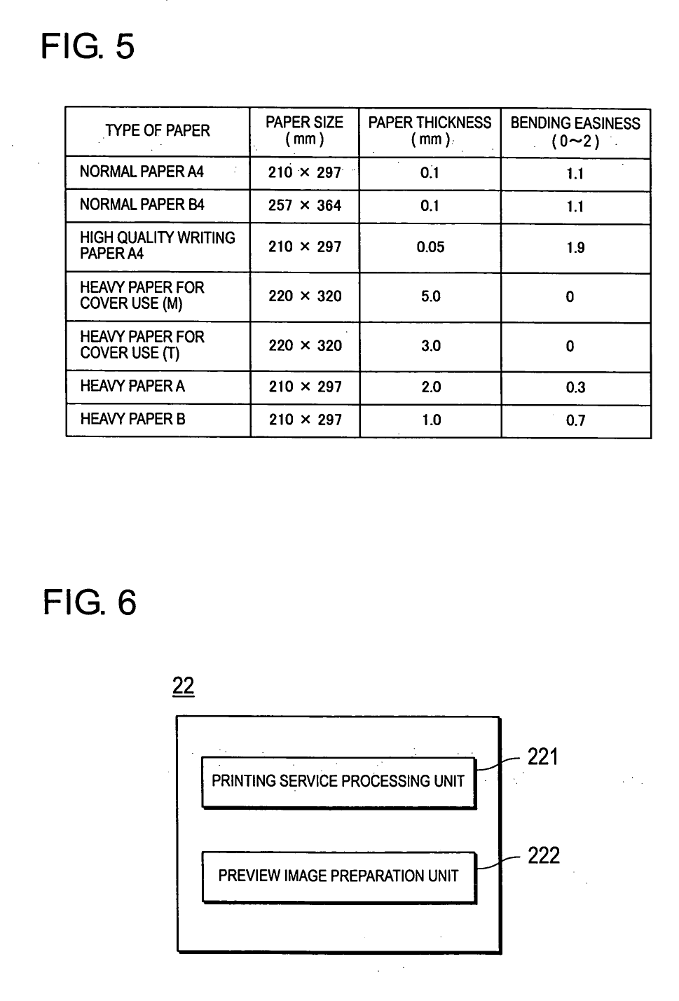

As shown in FIG. 4, the hard disk 24 provides specific areas for a paper information database 241 and a print data storage unit 242 for their exclusive uses respectively. The paper information database 241 stores the paper information indicating the attributes corresponding to the types of paper defined in this system. FIG. 5 is a diagram showing an example of the paper information list. The paper information list shown in FIG. 5 contains the paper size, the paper thickness, and the easiness of bending corresponding to each type of paper. The easiness of bending is the value that corresponds to the softness or the hardness of a type of paper, which will be discussed in detail later. The print data storage unit 242 stores print data to be outputted to the printer 30 to be printed.

As shown in FIG. 6, the ROM 22 provides specific areas for programs corresponding to a printing service processing unit 221 and a preview image preparation unit 222 respectively. The printing service processing unit 221 processes received preview request jobs or print request jobs. The preview image preparation unit 222 produces the preview image data for showing the state of completion of the book being produced based on the contents of the preview request job. The functions of the printing service processing unit 221 and the preview image preparation unit 222 are implemented as the CPU 21 executes their respective programs.

The printer interface 26 is an interface for communicating with the printer 30 and a dedicated video interface can be used for it.

The printer 30 prints the print data in the bitmap format transported from the server device 20 on a recording medium such as paper.

The client device 10 and the server device 20 can contain constitutional elements other than those described above, or may not include a portion of the above mentioned elements.

Next, we will describe the operations of the display system according to this embodiment constituted in such a way described above.

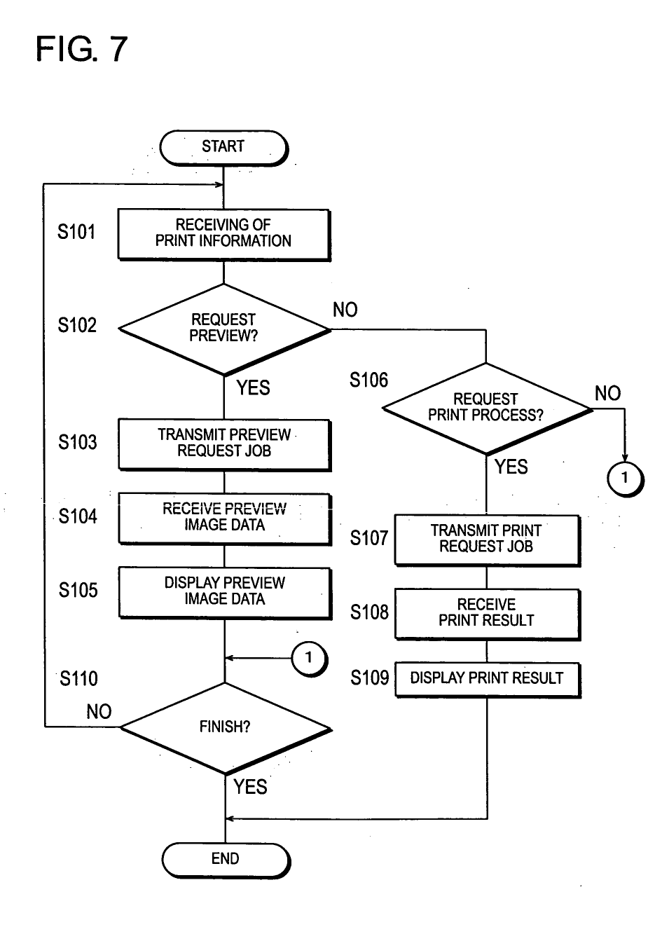

FIG. 7 is a flow chart showing the process procedure on the client device 10. The algorithm shown in FIG. 7 is stored in a storage unit such as the hard disk 14 as a program and is executed by the CPU 11.

As a preamble, let us assume that the image data to be printed has been specified.

In the step S101, the print information is accepted based on the user's input. The print information contains the job control information concerning jobs and the preview state information concerning preview state.

The job control information contains the type of paper, the paper size, the paper binding method, the paper binding position, and the dimensions of the binding margin. The preview state information contains the pickup position where the user is to pick up the paper when it is being turned over, and the page number of the paper being turned over. If the print processing including the book binding process is requested as in a case to be discussed later, the preview state information is not necessarily required

Next, a judgment is made as to whether the preview indicating the state of completion of the book being produced is requested (S102). Such a request is made based on the user's operation.

When it is judged that a preview is requested (S102: Yes), the client device 10 transmits a preview request job to the server device 20 (S103).

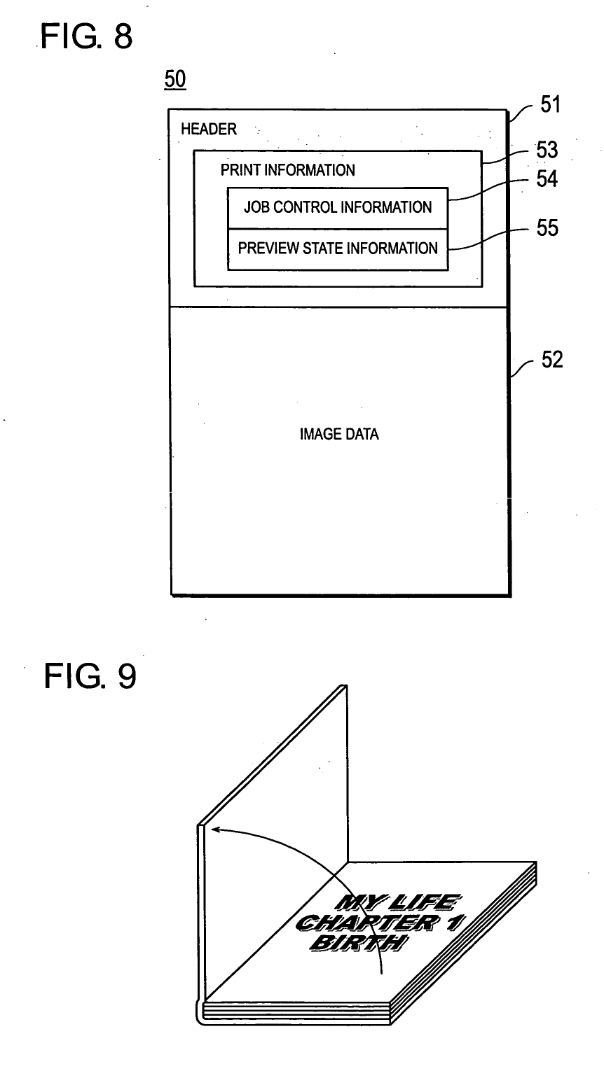

FIG. 8 is a diagram showing an example of a preview request job. As shown in FIG. 8, a preview request job 50 contains a header 51 and an image data 52. The header 51 contains job control information 54 received in the step S101 and print information 53 containing preview state information 55. The image data 52 is an image data preassigned to be printed on the paper.

Here, the server device 20 produces a preview image data based on the preview request job received from the client device 10 and returns the preview image data thus produced to the client device 10. The detail of these processes in the server device 20 will be described later.

The client device 10 receives the preview image data from the server device 20 (S104), and displays the received preview image data on the display 16 (S105).

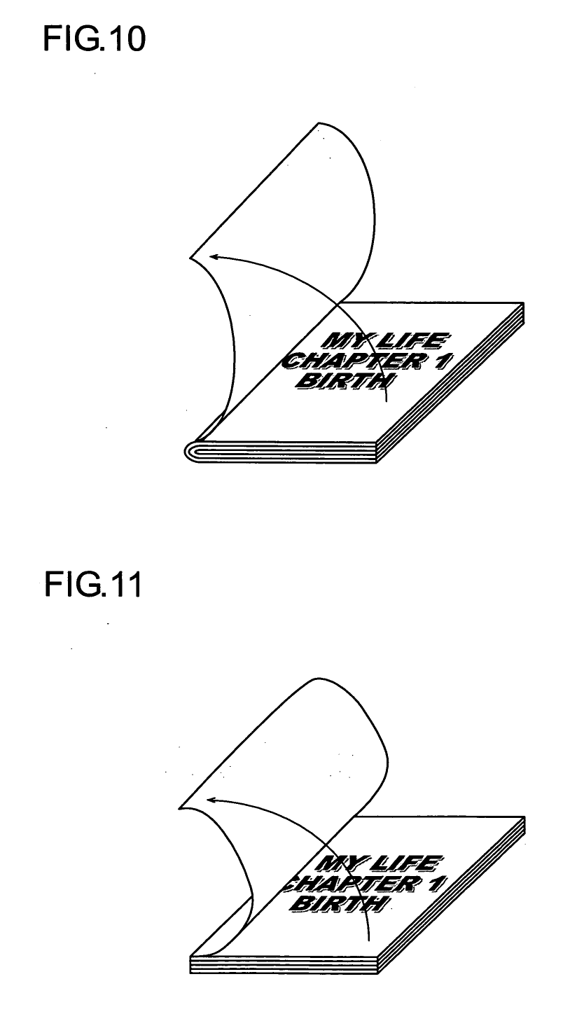

FIG. 9 shows a display example of the preview image data when heavy paper is selected for the cover, FIG. 10 shows a display example of the preview image data when normal paper is selected for a cover, and FIG. 11 shows a display example of the preview image data when fine quality writing paper is selected for a cover.

As shown in FIG. 9 through FIG. 11, the preview image data contains an image showing how the paper bends as it is being turned over, so that the user can grasp the state of completion of the book being produced beforehand accurately. Moreover, it is easy to grasp the state of completion as the state of completion of the book being produced is indicated in three-dimensions. The arrow in each drawing shows the trace of the pickup point travels as the paper is turned over.

In step S110, a judgment is made as to whether the completion instruction of the process shown in FIG. 7 is received. If the completion instruction is not received (S110: No), the program returns to the step S101. In this case, the user can modify the contents of the preview state information and display the preview image data again on the display unit 16. The user can request the print process including the book binding after checking the displayed preview image data.

On the other hand, if it is not judged that the preview was requested in the step S102 (S102: No), a judgment is made as to whether the print process including the book binding is requested or not (S106). Such a request is made based on the user's operation. If it is not judged that the print process is requested (S106: No), the program advances to the step S110.

When it is judged that a print process is requested (S106: Yes), the client device 10 transmits a print request job to the server device 20 (S107).

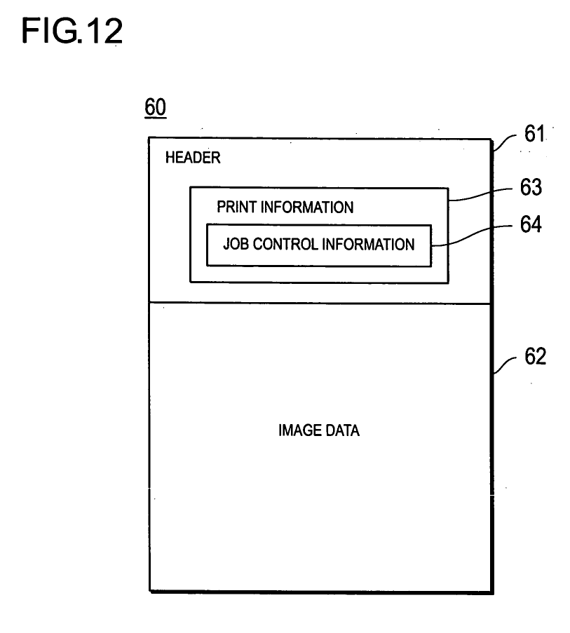

FIG. 12 is a diagram showing an example of a print request job. As shown in FIG. 11, a print request job 60 contains a header 61 and an image data 62. The header 61 contains print information 63 including job control information 64 received in the step S101. In other words, the print request job 60 is the same as the preview request job 50 except that the print information 63 does not contain the preview state information. In case of requesting a print process with the contents that match the preview request job, which has already been transmitted, a specified command can be transmitted instead of the print request job shown in FIG. 12.

The server device 20 issues a printing instruction to the printer 30 based on the print request job received from the client device 10, and transmits the print result to the client device 10. The detail of these processes in the server device 20 will be described later.

The client device 10 receives the print result from the server device 20 (S108), and displays the received print result on the display 16 (S109).

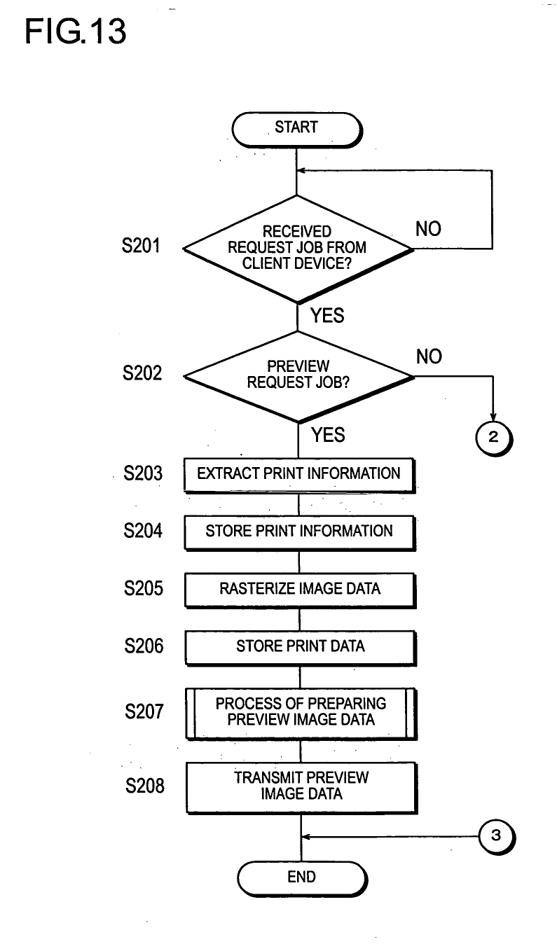

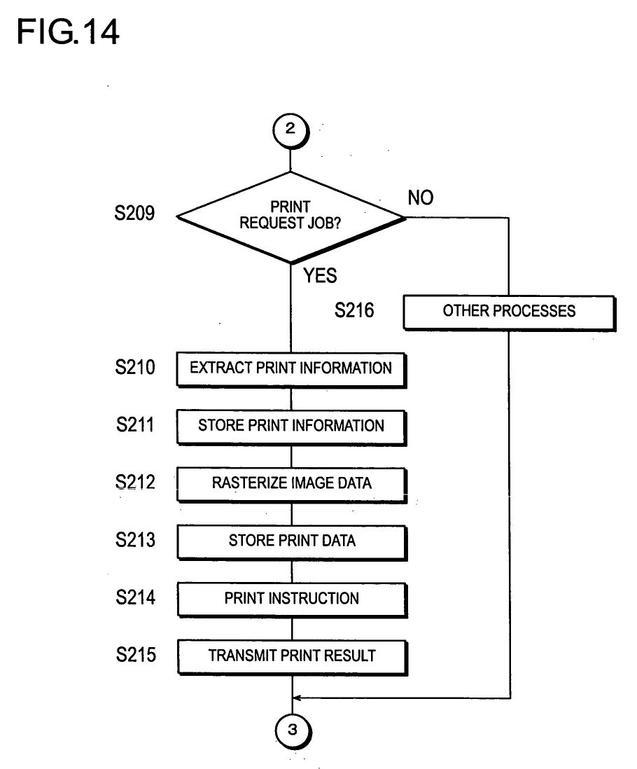

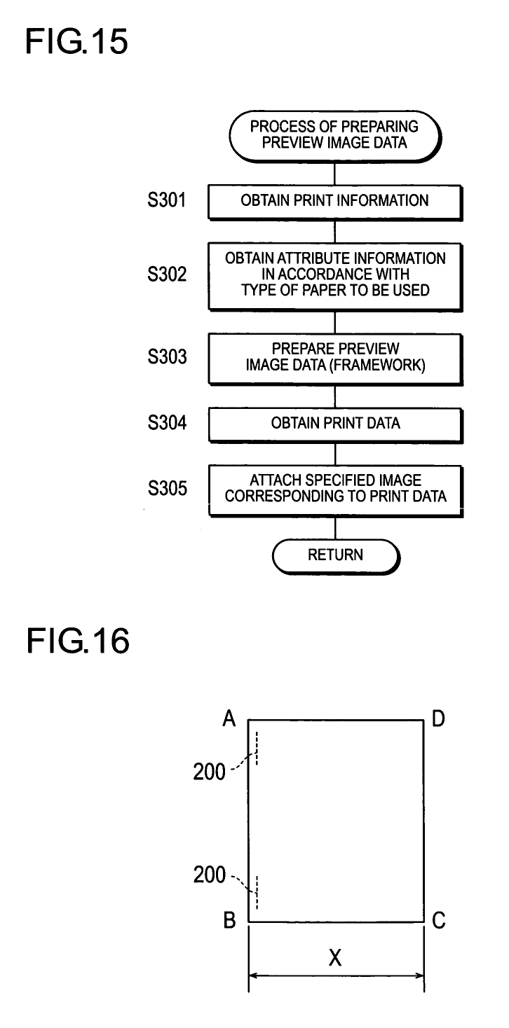

FIG. 13 through FIG. 15 are flow charts showing the process procedure on the server device 20. The algorithm shown in FIG. 13 through FIG. 15 is stored in the ROM 22 as a program and is executed by the CPU 21. The process shown in FIG. 13 and FIG. 14 is executed by the printing service process unit 221, and the process shown in FIG. 15 is executed by the preview image preparation unit 222.

The server device 20 stands by until a request job is received from the client device 10 (S201: No). In other words, the server 20 monitors the receipt of a request job from the client device 10.

Upon receiving a request job (201: Yes), the server device 20 makes a judgment as to whether the received request job is a preview request job or not (S202).

If the received request job is a preview request job (S202: Yes), a print information 53 containing the job control information 54 and the preview state information 55 is extracted from the preview request job 50 (S203). The extracted print information 53 is stored in a storage unit such as the RAM 23 (S204).

Next, the image data 52 in the preview request job 50 is rasterized (S205). The image data thus rasterized in the bitmap format is stored in the print data storage unit 242 of the hard disk 24 as the print data (S206).

Next, the preview image data is produced (S207). The detail of the process of preparing this preview image data will be described later.

The server device 20 transmits the produced preview image data to the client device 10, which is the source of the preview request (S208).

On the other hand, if the server device 20 judges in the step S202 that the received request job is not a preview request job (S202: No), it makes a judgment whether the received request job is a print request job or not (S209). If the received request job is not a print request job (S209: No), other processes in accordance with the requested contents are executed (S216).

If the received request job is a print request job (S209: Yes), print information 63 containing the job control information 64 is extracted from the print request job 60 (S210). The extracted print information 63 is stored in a storage unit such as the RAM 23 (S211).

Next, the image data 62 in the print request job 60 is rasterized (S212). The image data thus rasterized in the bitmap format is stored in the print data storage unit 242 of the hard disk 24 as the print data (S213). If a print process with the contents that match with those of the already received preview request job is requested, the storing of the print information (S211) and the storing of the print data (S213) can be omitted.

Next, the server device 20 issues a print instruction to the printer 30 based on the print information 63 and the print data. At this point, the printer 30 executes the print process including the book binding process based on the print instruction from the server device 20.

The server device 20 transmits the print result to the client device 10, which is the source of the print request (S215). The print result includes the print process completion notice and specified error occurrence notices.

Next, the preparation process of the preview image data in the step 207 will be described below with reference to FIG. 15.

First, the preview image preparation unit 222 of the server device 20 obtains the print information 53 stored in the RAM 23 (S301). As mentioned in the above, the print information 53 contains the job control information 54 including the type of paper, the paper size, the paper binding method, the paper binding position, the width of the binding margin and such as well as the preview state information 55 including the paper pickup position and the page number of the paper being turned over.

Next, the paper information is obtained indicating the attribute corresponding to the type of paper being used from the paper information database 241 (S302). As described above, the paper information contains the paper size, the paper thickness, and the easiness of bending corresponding to each type of paper (see FIG. 5).

The preview image data (framework) containing an image showing how the paper being turned over bends is produced based on the print information 53 and the paper information (S303). The detail of the process of preparing this preview image data will be described later.

Next, the print data stored in the print data storage unit 242 is obtained (S304). This print data corresponds to the print information 53 obtained in the step S301.

The specific image corresponding to the print data is attached to the preview image data (framework) to complete the preview image data (S305). In other words, a specific image corresponding to the print data that is to be printed in the particular area is added to the external view of the paper on the preview data. The detail of this process of attaching the specific image corresponding to the print data will be described-later.

Next, the method of preparing the preview image data in the abovementioned display system will be described in detail below. In this embodiment, preview image data are produced including the image showing how the paper being turned over bends in correspondence with the type of paper and the location of the paper where it is picked up.

The preview image data is produced here in order to convey the texture of the paper being used visually to the user. In other words, it is not necessary to reproduce in high fidelity the performance and physical state of the paper when it is being turned over. Therefore, the method of processing such as calculation formulas used for preparing the image showing how the paper bends is not limited to one. The following is one of them.

In this embodiment, the binding position of the paper is specified. The binding position is specified either as a side binding wherein the paper is bound on one side or as a corner binding wherein the paper is bound on one corner.

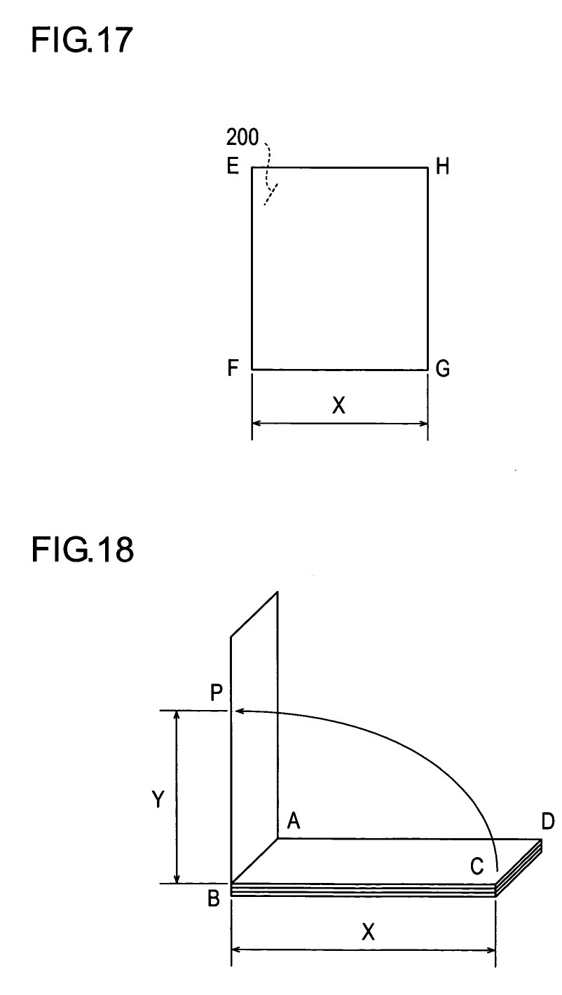

FIG. 16 is a plan view showing an example of the left side binding, while FIG. 17 is a plan view showing an example of the top left corner binding. In these cases, the side BC in FIG. 16 and the side FG in FIG. 17 are defined as the datum side (length X). Similar rules are applied on cases with other binding positions. In FIG. 16 and FIG. 17, the binding positions are indicated by staples 200. Of the points A through H, the points A, B, and E are forbidden from being assigned as the pickup points (including their vicinities). The turnover procedure for a case wherein the pickup position is the point D is similar to that for a case wherein the pickup position is the point C. Also, the turnover procedure for a case wherein the pickup position is the point H is similar to that for a case wherein the pickup position is the point D, so that it is handled similarly. Also, the turnover procedure for a case wherein the pickup position is the point F is similar to that for a case wherein the pickup position is the point H, except that the paper turnover direction is different. Next, the procedure for each case where the pickup position is the point C or G will be described below.

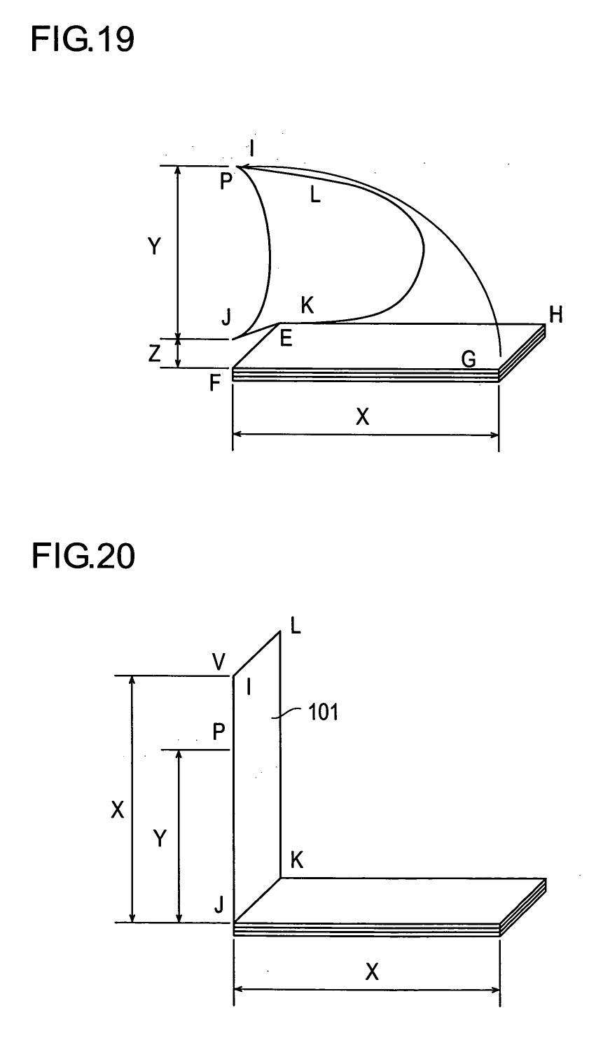

FIG. 18 is a diagram for describing the trace of the pickup point when the binding is on the left side and the pickup point is at the point C, while FIG. 19 is a diagram for describing the trace of the pickup point when the binding is on the top left corner and the pickup point is at the point G. In the following explanations, the four apexes of the paper being turned over are named I, J, K, and L for the sake of the convenience.

In the present embodiment, the preview image data is that of three dimensional drawing such as a perspective view. In the preview image data, the trace of the pickup point is unilaterally defined regardless of how the paper bends in order to be able to express the turn over action in a simple way. The trace of the point C, which is the pickup point in the case shown in FIG. 18, is drawn as a line starting at the point C and ending at a point P, which is located at a height Y straight up above the point B. The height Y here is, for example, ¾ times of the length X of the datum side (Y=X*¾). In this case, the line the trace produces is a part of an ellipse with a minor radius of Y and a major radius of X. Also, as shown in FIG. 19, the point J of the paper being turned over is expressed to be away from the point F by the offset length Z if it is a case of the corner bind and the pickup position is the point G. The offset length Z in this case is a value predetermined in case of the corner binding. The trace of the point G, which is the pickup position, is drawn as a line starting at the starting point G and ending at a point P, which is located at a height (Y+Z) straight up above the point F. In this case, the line the trace produces is a part of an ellipse with a minor radius of (Y+Z) and a major radius of X. The point P is the ending point of the trace of the pickup point in both FIG. 18 and FIG. 19.

Next, let us describe the method of preparing an image showing how the paper bends when it is turned over. First, let us describe a case wherein the paper is bound on the left side.

FIG. 20 through FIG. 23 are diagrams showing exampled of the preview image data each including an image showing how a cover is bent when the cover is turned.

The way the paper bends is determined in accordance with the easiness of bending a found in the paper information obtained from the paper information database 241. The bending easiness α is a value that corresponds to the softness or hardness of the paper as mentioned before. Paper with a bending easiness of α=0 is the hardest paper among the papers defined, which does not bend at all, while paper with a bending easiness of α=2 is the softest paper among the papers defined.

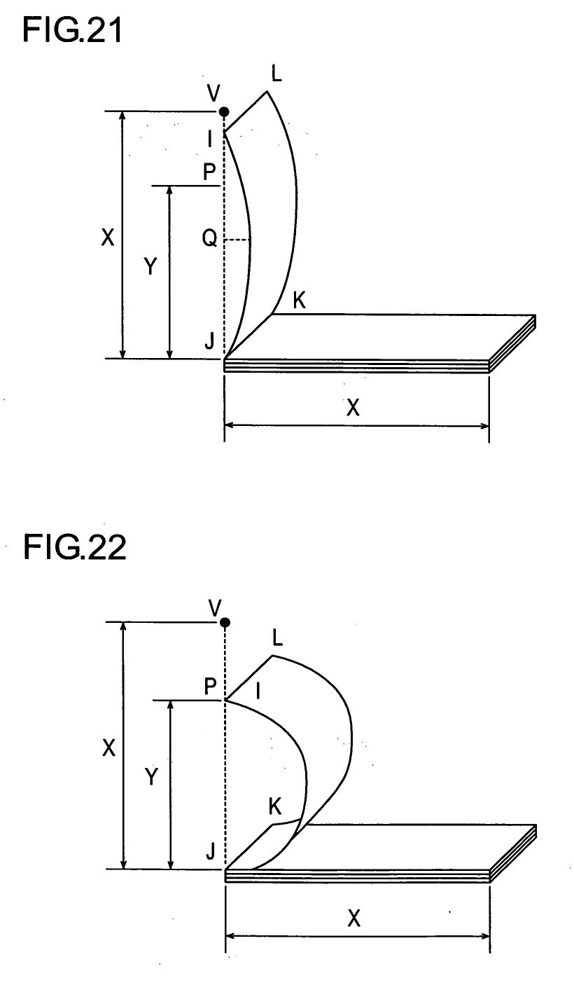

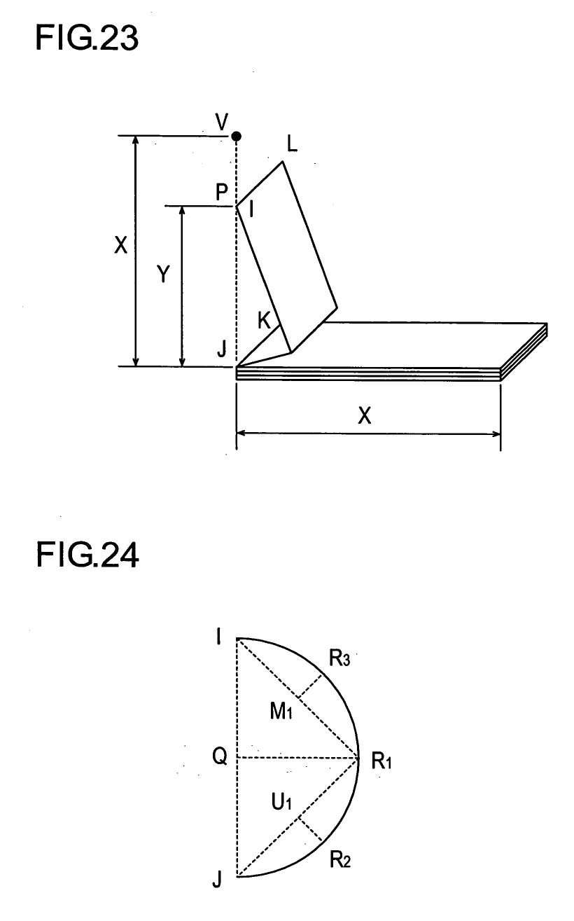

FIG. 20 is a diagram showing a case wherein the cover is made of paper with a bending easiness of α=0, FIG. 21 is a diagram showing a case wherein the cover is made of paper with a bending easiness of α=0.5, FIG. 22 is a diagram showing a case wherein the cover is made of paper with a bending easiness of α=1, and FIG. 23 is a diagram showing a case wherein the cover is made of paper with a bending easiness of α=2.

In this embodiment, the mode of bending of the paper is shown continuously in accordance with the bending easiness of 0≦α≦2 that is a real number. The method of preparing an image indicating how the paper is bent will be described below using FIG. 20 through FIG. 26. The dotted lines are shown only for the purpose of description and are not included in the preview image data. Also, the embodiment is not limited to the line hiding process used for the preview image data as shown in FIG. 20 through FIG. 23, and the line hiding process is not necessarily have to be done.

If the bending easiness α is equal to or larger than 0 and equal to or smaller than 1, the point 1 moves from the point V to the point P in accordance with the bending easiness α (refer to FIG. 20 through FIG. 22). The point V is located at a height X straight up above the point J and the point P is located at a height Y straight up above the point J. The height Y here is ¾ times of the length X of the datum side (Y=X*¾). As shown in FIG. 21, the arc-shaped side IJ is drawn as a part of an ellipse having its center at a point Q which is the middle point between the point I and the point J. The major radius of the ellipse is IQ and the minor radius is (½*(X−the length of IJ)). The side LK having an arc shape is drawn by translating the side IJ in parallel.

If the bending easiness α is equal to or larger than 1 and equal to or smaller than 2, the point I is fixed on the point P and the shape of the side IJ alone changes (refer to FIG. 22 and FIG. 23). The side LK is drawn by translating the side IJ in parallel. The change of the shape of the side IJ will be described referring to FIG. 24 through FIG. 26.

As shown in FIG. 24, when the bending easiness α=1, let the intersection between a line drawn from the point. Q perpendicular to the line segment IJ and the curve IJ be called R₁. Also, a point R₂ is defined between the point R₁ and the point J on the curve IJ. The point R₂ is assumed to be a middle point between the point R₁ and the point J. The datum point R used in the drawing moves from the point R₁ to the point R₂ depending on the bending easiness α.

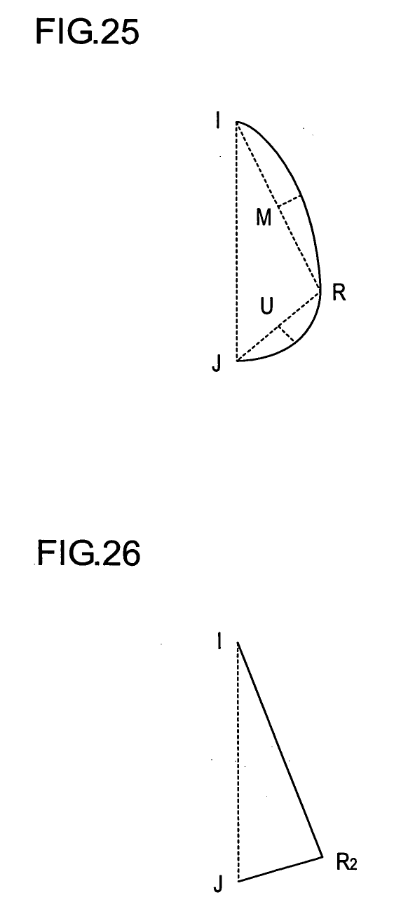

As shown in FIG. 25, the side IJ consists of a curve IR and a curve RJ when the bending easiness α is larger than 1 and smaller than 2. The curve IR and the curve RJ can be modified in such a way as to make them connect smoothly at their junction point. The curve IR is expressed as a part of an eclipse having its center at the middle point M of the line segment IR. For this ellipse, the major radius is defined as (½*(length of line segment IR)) and the minor radius is defined to decrease gradually from the minor radius M₁R₃ (maximum value; see FIG. 24), which is the minor radius when the bending easiness α=1, to zero (or a specified value close to zero; see FIG. 26) when the bending easiness α=2 depending on the bending easiness α. The curve RJ is expressed similarly as a part of an ellipse having its center at a point U which is the middle point of the line segment RJ. For this ellipse, the major radius is defined as (½*(length of line segment RJ)) and the minor radius is defined to decrease gradually from the minor radius U₁R₂ (maximum value; see FIG. 24), which is the minor radius when the bending easiness α=1, to zero (or a specified value close to zero; see FIG. 26) when the bending easiness α=2 depending on the bending easiness α.

Also, as shown in FIG. 19, an image for showing how the paper bends when the paper bound at a corner is turned over can be produced in the similar manner as in the case when the paper is bound on the left side as shown in FIG. 20 through FIG. 26, except that the image location shifts upward by the amount of the offset length Z. The side LK of the arc shape is drawn here by translating the side IJ in parallel. However, in order to obtain a more effective image from the visual standpoint, the major radius of the ellipse of the side LK can be assigned to a value obtained by reducing the major radius of the side IJ by a fixed ratio (e.g., 0.75).

Next, the method of preparing a preview image data, where the width dimension of the binding margin and the thickness of the paper are expressed, will be described.

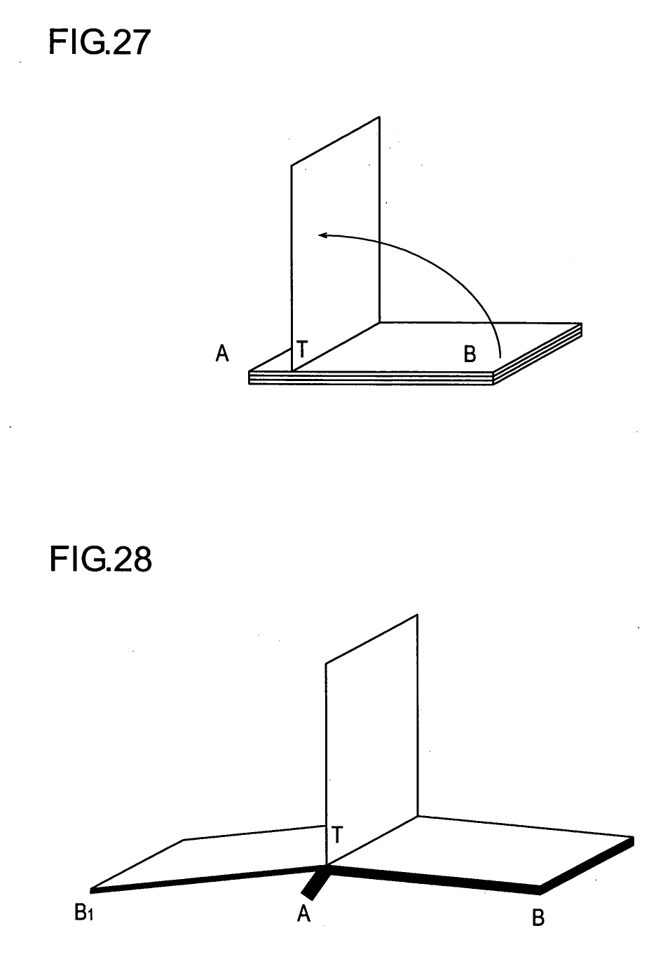

FIG. 27 is an example of preview image data showing a binding margin. The bending easiness α of the paper shown in FIG. 27 is zero. The width dimension of the binding margin is expressed by the length of the line segment TA on the side AB.

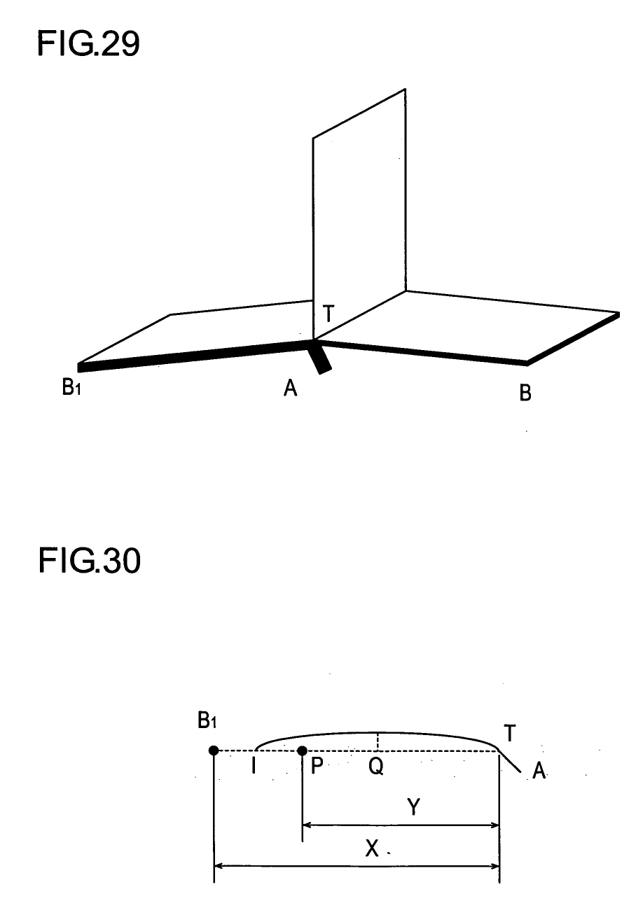

While the total thickness of the paper can be defined in proportion to the length of the side AB, it can be defined as a predefined fixed value for the sake of simplicity. The side of the stacked paper can be expressed either by parallel lines separated by a certain distance (see FIG. 27), or can be expressed by a blacked out thick line (FIG. 28 and FIG. 29). In this case, the image for showing how the paper being turned over bends is produced in such a way as to show how the side TB is turned around the point T. In other words, an image showing how the paper bends is produced using the same method as the method of preparation described using FIG. 20 through FIG. 26.

Next, let us describe the method of preparing a preview image data for a case when paper of an intermediate page is turned.

FIG. 28 is a diagram showing an example of preview image data when the first ⅓ of the pages are turned over, while FIG. 29 is a diagram showing an example of preview image data when the first ⅔ of the pages are turned over. The bending easiness α of the paper shown in FIG. 28 and FIG. 29 is zero.

Assuming the total number of pages is N and the page number of the paper being turned is n, the paper of pages 1 through (n−1) are placed on the left side of the preview image data (in case of the left side binding), and the paper of pages (n+1) through N are placed on the right side of the preview image data (in case of the left side binding) as shown in FIG. 28 and FIG. 29. In other words, an image showing a state where an intermediate page of the book is opened is prepared. In the drawing, the point B₁ is the corner of the paper already turned, which corresponds to the point B of the paper not yet turned. Here, the thickness of the side TB₁ is assigned to a value corresponding to the number of pages already turned (n−1), the thickness of the side TB is assigned to the thickness of the page (N−n) of the paper yet to be turned, and the thickness of the side TA is assigned to the thickness of the total number of pages of the book N. However, the thickness of each side needs not be accurately proportional but rather can be modified to a thickness by which the user can generally see the difference between the number of pages of paper already turned and the number of pages of paper yet to be turned. It can reflect the thickness of the actual thickness of the paper if so desired.

In FIG. 28 and FIG. 29, the side TA is assigned to a position where it is turned about the point T for an angle corresponding to the size of n. For example, the angle ATB is set at 180° when n=1; the angle ATB is set at 90° when n=½*N; and the angle ATB is set at 0° when n=N. The points B₁ and B are adjusted so that they are aligned with the point A to be on the same level in the vertical direction in the preview image data. In other words, the sides TB₁ and TB are expressed in tilted positions in accordance with the setting of the angle ATB. Thus, the user can grasp the state of the completed book more easily.

Next, let us describe the method of preparing a preview image data for a case when an intermediate page is turned when the bending easiness α of the paper is larger than 0. Only the points which are different from the method of preparation described using FIG. 28 and FIG. 29.

An image shows how the already turned paper and the paper yet to be turned are bent as well as how the paper being turned bends in this case. The method of preparing an image showing how the paper being turned bends is the same as described using FIG. 20 through FIG. 26. Since the already turned paper bends in a similar way as the paper yet to be turned, let us describe the method of preparing an image for showing how the already turned paper bends.

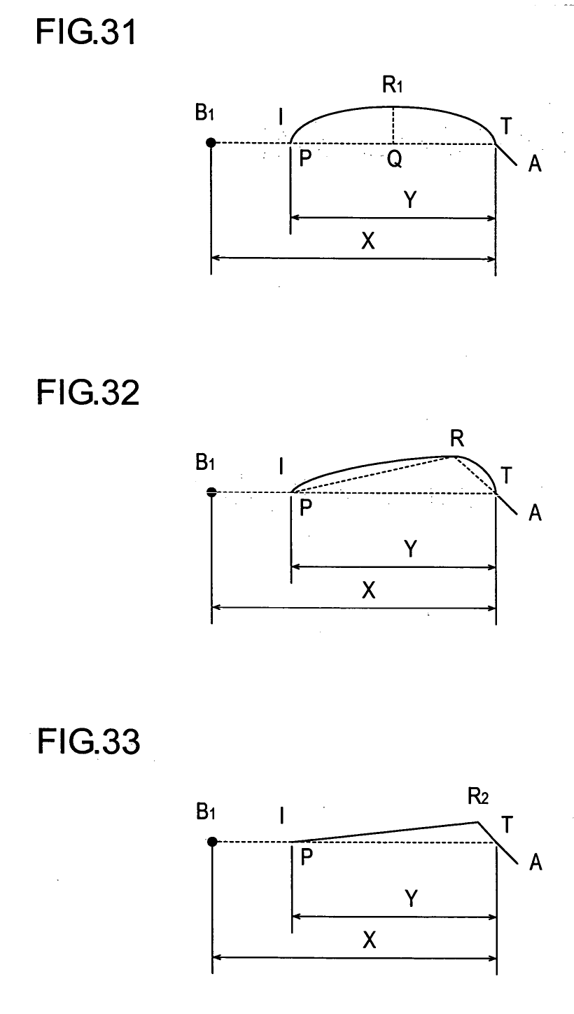

FIG. 30 through FIG. 33 are diagrams for describing how the already turned paper bends The way the already turned paper bends is determined in accordance with the bending easiness α found in the paper information obtained from the paper information database 241. FIG. 30 is a diagram showing a case when the bending easiness α is larger than 0 and smaller than 1, FIG. 31 is a diagram showing a case when the bending easiness α=1, FIG. 32 is a diagram showing a case when the bending easiness α is larger than 1 and less than 2, and FIG. 33 is a diagram showing a case when the bending easiness α=2.

In FIG. 30 through FIG. 33, the point I represents a point on the tip of an already turned paper, the point B₁ represents a point exactly left of the point T whose distance X from the point T corresponds to the length of the side TB (see FIG. 27 through FIG. 29), and the point P represents a point exactly left of the point T whose distance Y from the point T corresponds to (¾) times of the length of the side TB (Y=X*¾).

If the bending easiness α is larger than 0 and smaller than 1, the point I moves from the point B₁ to the point P in accordance with the bending easiness α. As shown in FIG. 30, the arc-shaped side IT is drawn as a part of an ellipse having its center at a point Q which is the middle point between the point I and the point T. The major radius of the ellipse is IQ and the minor radius is (½*(X−the length of IT)).

If the bending easiness α is equal to or larger than 1 and equal to or smaller than 2, the point I is fixed on the point P and the shape of the side IT alone changes. The change of the shape of the side IT will be described referring to FIG. 31 through FIG. 33.

As shown in FIG. 31, when the bending easiness α=1, let the intersection between a line drawn from the point Q perpendicular to the line segment IT and the curve IT be called R₁. Also, a point R₂ is defined between the point R₁ and the point T on the curve IT (see FIG. 33). The point R₂ is a point closer to the point T by a specific distance than the middle point between the point R₁ and the point T. The datum point R used in the drawing moves from the point R₁ to the point R₂ depending on the bending easiness α.

As shown in FIG. 32, the side IT consists of a curve IR and a curve RT when the bending easiness α is larger than 1 and smaller than 2. The curve IR and the curve RT can be modified in such a way as to make them connect smoothly at their junction point. The curve IR is expressed as a part of an eclipse having its center at the middle point of the line segment IR. For this ellipse, the major radius is defined as (½*(length of line segment IR)) and the minor radius is defined to decrease gradually from the minor radius (maximum value; see FIG. 31), which is the minor radius when the bending easiness α=1, to zero (or a specified value close to zero; see FIG. 33) when the bending easiness α=2 depending on the bending easiness α. The curve RT is expressed similarly as a part of an ellipse having its center at the middle point of the line segment RT. For this ellipse, the major radius is defined as (½*(length of line segment RT)) and the minor radius is defined to decrease gradually from the minor radius (maximum value; see FIG. 31), which is the minor radius when the bending easiness α=1, to zero (or a specified value close to zero; see FIG. 33) when the bending easiness α=2 depending on the bending easiness α.

A three dimensional preview is produced based on the information thus obtained on how the already turned paper turns.

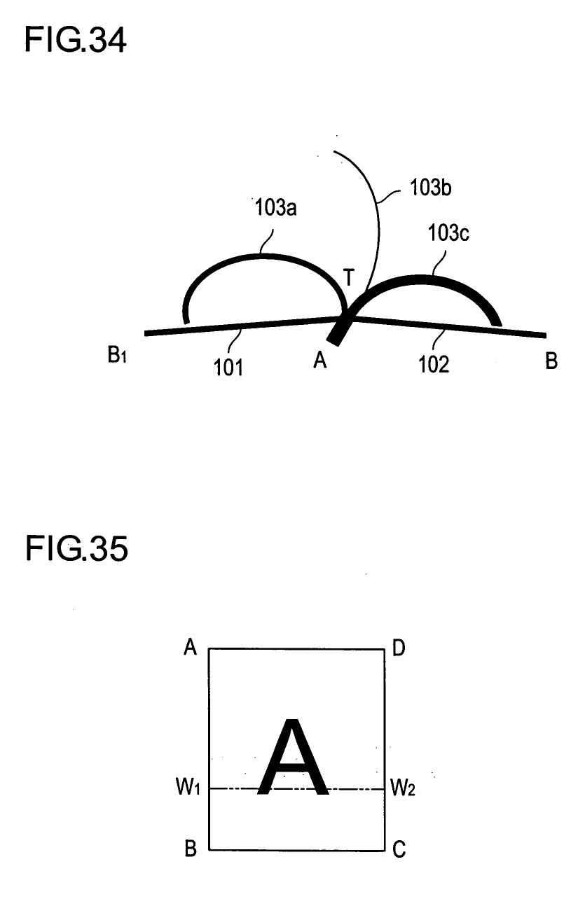

FIG. 34 is a diagram for describing how the paper bends when the paper used for the cover and the back cover of the book being produced is different from the paper used for pages other than the cover and the back cover.

In this case, the preview image data is produced to contain the images showing how each paper bends depending on the difference between the type of paper used for the cover 101 and the back cover 102 and the type of paper 103a through 103c used for pages other than the cover and the back cover, more specifically their bending easiness α. In FIG. 34, the bending easiness α of the cover 101 and the back cover 102 is 0, and the bending easiness α of the already turned paper 103a, the paper being turned 103b, and the paper yet to be turned 103c is larger than 0. A three dimensional preview is thus produced based on the information thus obtained on how each paper turns.

Next, the method of attaching the specified image corresponding to the print data to the preview image data (framework) will be described below referring to FIG. 35 through FIG. 38.

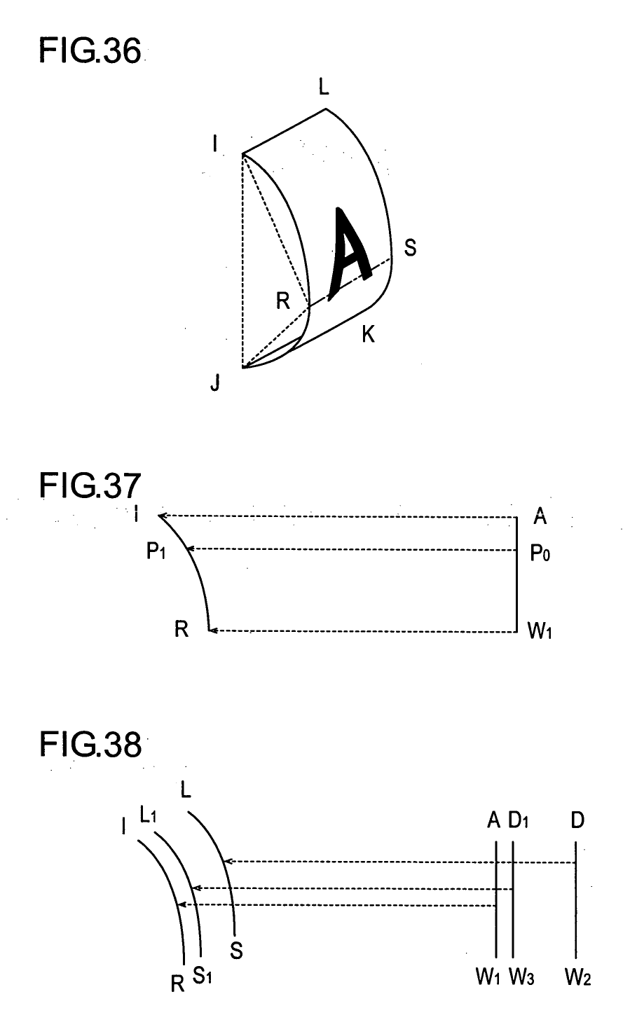

FIG. 35 is a plan view showing an example of paper where the specified image corresponding to the print data is printed, and FIG. 36 is a diagram showing an example image of how the paper on which the image shown in FIG. 35 is printed bends.

The curve IR and the curve RJ shown in FIG. 36 correspond to the curve IR and the curve RJ shown in FIG. 25 respectively. The curve LS and the curve SK are drawn by translating the curve IR and the curve RJ in parallel respectively. In FIG. 35, the point W₁ is a point where the relation of (the length of the curve IR): (the length of the curve RJ)=(the length of the line segment AW₁): (the length of the line segment W₁B) holds, and the point W₂ is a point where the relation of (the length of the curve LS) (the length of the curve SK)=(the length of the line segment DW₂): (the length of the line segment W₂C) holds.

First, let us describe the process of attaching the image to the curved surface IRSL. As shown in FIG. 37, a point P₀ that corresponds to the point P₁ traveling on the curve from the point I to the point R is found on a line segment from the point A to the point W₁ to satisfy a relation of (the length of the curve IP₁): (the length of the curve P₁R)=(the length of the line segment AP₀): (the length of the line segment P₀W₁). The pixel information of the point P₀ (black or white in case of monochromatic printing, density of each color such as RGB in case of color printing) is assigned to the pixel information of the point P₁. The movement pitch of the point P₁ that moves on the curve IR should preferably be matched with the display resolution of the preview image data.

When the preparation of the image on the curve IR is completed, the image on a curve L₁S₁ obtained by translating the curve IR by a specific amount toward the curve LS is also produced as shown in FIG. 38. At this time, a line segment D₁W₃ corresponding to the curve L₁S₁ is obtained by translating the line segment AW₁ by a specific amount toward the line segment DW₂. The movement of the line segment AW₁ is done at such a rate that the line segment AW₁ overlaps the line segment DW₂ when the curve IR overlaps the curve LS. The movement pitch of the line segment AW₁ should preferably be matched with the display resolution of the preview image data as well. The attachment of the image to the curved surface RJKS should be done in a similar manner.

As shown in FIG. 19, the curve IJ is translated a specific amount toward the curve LK while being scaled down at a specific rate, if the length of the curve LK is smaller than the length of the curve IJ.

Also, preview image data showing different binding methods depending on the binding methods contained in the print information can be produced in the present embodiment. If the most commonly used “plain binding” is specified, an image of the paper binding part showing the “plain binding” will be produced as shown in FIG. 9 (when the heavy paper for cover use is used for the cover) and FIG. 11 (when paper other than the heavy paper for cover use is used for the cover)

If the “saddle stitch,” which is often used in weekly magazines, is specified, an image of the paper binding part showing the “saddle stitch” will be produced as shown in FIG. 10. In this case, the preview image data is produced by assigning 0 to the length of the line segment TA, which is the width of the binding margin in the method described in FIG. 27 through FIG. 33.

Thus, the present embodiment can produce a preview image data showing the completed state of a book being produced indicating how the turned paper bends and display such a view.

According to this invention, the user can therefore check a preview image data including an image showing how the paper bends as it is turned over on a display before book binding actually. This is how it is made possible for the user to accurately grasp beforehand the completed condition of a book being produced, so that it is possible to avoid a book from being produced differently from what the user intended. This assures the user a more satisfactory result from the book making and prevents the user from having to be in a position to reorder.

It is obvious that this invention is not limited to the particular embodiments shown and described above but may be variously changed and modified without departing from the technical concept of this invention.

For example, although the bending easiness and thickness of the paper are used as the paper information in order to produce the preview image data in the embodiment described above, the invention is not limited to it and other attribute information such as the bending strength and weight (mass) of the paper can be used.

Moreover, an image showing how the paper bends can be produced based on multiple patterns of simulations performed in advance. For example, it can be expressed limiting to four patterns of diagrams shown in FIG. 20 through FIG. 23. In this case, the image showing how the paper bends is produced by approximating the diagram based on the bending easiness α, which is closest to the bending easiness of the paper to be used.

Although the embodiment describe above assumed a display system wherein the client device 10 and the server device 20 are communicably connected with each other via the network 40, the invention is not limited to it. The invention can be constituted as a single display device combining the client device 10 and the server device 20.

The means and method of conducting various processes in the display system or the display device according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is normally transferred to and stored in a memory unit such as a hard disk. Said program can also be provided as independent application software or can be built into the software of the display system or the display device as a part of the system or device's function.

1. A display device, comprising:
a storage unit for storing a plurality of types of paper;
a paper selection unit for selecting a type of paper to be used;
a preview image preparation unit for preparing preview image data for showing a completed state of a book being produced containing an image showing how paper being turned bends depending on the type of paper selected; and
a display unit for displaying the prepared preview image data.

2. A display device as claimed in claim 1 further comprising:
a pickup position specifying unit for specifying a pickup position for turning the paper, wherein
said preview image preparation unit prepares the preview image data depending on the selected type of paper and the specified paper pickup position.

3. A display device as claimed in claim 1 further comprising:
a binding position specifying unit for specifying a paper binding position, wherein
said preview image preparation unit prepares the preview image data showing the binding position depending on the selected type of paper and the specified paper binding position.

4. A display device as claimed in claim 1 further comprising:
a binding method specifying unit for specifying a paper binding method, wherein
said preview image preparation unit prepares the preview image data showing the binding method depending on the selected type of paper and the specified paper binding method.

5. A display device as claimed in claim 1 further comprising:
a binding margin dimension specifying unit for specifying a width dimension for a binding margin to be used for binding on one side of the paper, wherein
said preview image preparation unit prepares the preview image data showing the binding margin width dimension depending on the selected type of paper and the specified paper binding margin dimension.

6. A display device as claimed in claim 1 further comprising:
a page number specifying unit for specifying a page number of the paper to be turned, wherein
said preview image preparation unit prepares the preview image data showing a total thickness of paper having page numbers smaller than the specified page number of the paper being turned and a total thickness of paper having page numbers larger than the specified page number of the paper being turned depending on the selected type of paper and the specified page number of the paper to be turned.

7. A display device as claimed in claim 6, wherein
said preview image data contains an image showing how the paper having page numbers smaller than the page number of the paper being turned bends and an image showing how the paper having page numbers larger than the page number of the page being turned bends.

8. A display device as claimed in claim 7, wherein
when the type of paper to be used for the cover and the back cover of the book being produced is different from the type of paper to be used for other parts of the book other than the cover and the back cover, said preview image data containing an image showing how each paper bends depending on the type of paper is prepared.

9. A display device as claimed in claim 1, wherein
said preview image preparation unit adds to an external view part on said preview image data a specified image corresponding to data to be printed on said part.

10. A display device as claimed in claim 2, wherein
said preview image data has an image showing said pickup position's trace generated as the paper is turned.

11. A display device as claimed in claim 1, wherein
said preview image data shows a completed state of the book being produced in three dimensions.

12. A display system, comprising:
a client device; and
a server device communicable with said client device, wherein
said client device including:
a paper selection unit for selecting a type of paper to be used;
a transmission unit for transmitting information regarding the selected paper type to said server device;
a reception unit for receiving from said server device preview image data showing the completed state of the book being produced indicating how paper being turned bends;
a display unit for displaying the received preview image data;
said server device including:
a reception unit for receiving from said client device information regarding the selected type of paper;
a preview image preparation unit for preparing the preview image data in accordance with the received information regarding the type of paper; and
a transmission unit for transmitting the prepared preview image data to said client device.

13. A display system as claimed in claim 12, wherein
said client device further comprising a pickup position specifying unit for specifying a pickup position for turning the paper, wherein
said transmission unit of said client device transmits the selected type of paper and the specified paper pickup position to said server device;
said reception unit of said server device receives the selected type of paper and the specified paper pickup position from said client device;
said preview image preparation unit of said server device prepares the preview image data in correspondence with the received information regarding the type of paper and the paper pickup position.

14. A display method comprising the steps of:
1) receiving the selection of the type of paper intended to be used among a plurality of types of paper stored in the storage unit;
2) preparing preview image data for showing a completed state of a book being produced containing an image showing how paper being turned bends depending on the type of paper selected; and
3) displaying the prepared preview image data.

15. A display method as claimed in claim 14, further comprising the step of:
4) receiving a designation of a pickup position for turning the paper, wherein
in the step 2), the preview image data is prepared in accordance with the selected type of paper and the specified paper pickup position.
